(19) United States
(12) Patent Application Publication
(10) Pub. No.: US 2026/0023740 A1
(43) Pub. Date: Jan. 22, 2026

(54) OPERATIONAL METRIC SUPPORT ON A CLOUD-BASED OBSERVABILITY PLATFORM

(71) Applicant: Cisco Technology, Inc., San Jose, CA (US)

(72) Inventors: Anna Esther Min, Emeryville, CA (US); Brian Robert Zaik, Long Beach, CA (US); Tom Thekkel Jose, Milpitas, CA (US); Jaideep Padhye, San Jose, CA (US); Aditya Mehra, Dehradun (IN); Najuka Prakash Sankhe, San Jose, CA (US); Vishweshwar Ghanakota, Cardiff, CA (US); Daniel Q. Erwin, Oakland, CA (US)

(73) Assignee: Cisco Technology, Inc., San Jose, CA (US)

(21) Appl. No.: 18/776,620

(22) Filed: Jul. 18, 2024

(51) Int. Cl. G06F 16/23

(52) U.S. Cl. CPC G06F 16/2379

(57) ABSTRACT

In one implementation, a device may obtain operational attributes across a plurality of spans associated with a monitored transaction over a network. The device may provide the operational attributes for configuration as an operational metric attribute and as dimension attributes corresponding to the operational metric attribute. The device may generate, based on the configuration, an operational metric measurement corresponding to the operational metric attribute and one or more dimensions corresponding to the dimension attributes. The device may provide the operational metric measurement for at least one of the one or more dimensions for operational analysis.

### TECHNICAL FIELD

The present disclosure relates generally to computer networks and, more particularly, to operational metric support on a cloud-based observability platform.

### BACKGROUND

Online transactional platforms are becoming increasingly complex systems that include many services (e.g., micro-services) hosted across a wide variety of locations. For instance, consider the case of retail transactions over a retailer's online platform, where a user first logs into their account, then browses for products, adds selected products to their cart, enters shipping and payment information, confirms their order, and then checks out to complete the purchase. Underlying each of these transactional milestones from the standpoint of a user may be the various services associated with the retail application. For example, a user logging into their account may entail their mobile app connecting to identity services, the checkout may entail sending their credit card information to appropriate financial services for approval, etc.

Today, the majority of solutions for monitoring the operational metrics of an online transactional platform rely on custom metrics or OpenTelemetry span metrics for their needs. The challenge with these is that not all dimensions that are required to analyze the metric data are available in the same span. This makes collecting metric measurement and dimensions from attributes from different spans are complex to configure and maintain, often requiring code changes and multiple iterations. Further, in modern distributed architectures in the cloud, an application may consist of multiple microservices. A single business transaction can have spans across 10s or 100s of microservices. In such deployments, it is difficult to correlate different dimensions for the same metric across spans.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4A-4B illustrate examples of instrumentations of code to provide an attribute of a span;

FIG. 5 illustrates an example service map for an observability and performance monitoring application;

FIG. 6 illustrates an example trace view of an operational transaction;

FIG. 7 illustrates an example screen display presented by a user interface to the user for configuration;

FIGS. 8A-8B illustrate examples of selection interfaces for selecting segmentation of metric data in an operational configuration interface;

FIG. 9 illustrates an example of a conversion rate template for operational metric support on a cloud-based observability platform;

FIG. 10 illustrates an example of an operational metric analysis interface for operational metric support on a cloud-based observability platform;

FIG. 11 illustrates an example of a health rule configuration interface for operational metric support on a cloud-based observability platform;

FIG. 12 illustrates an example of a health rule evaluation condition configuration interface for operational metric support on a cloud-based observability platform; and

FIG. 13 illustrates an example simplified procedure for operational metric support on a cloud-based observability platform in accordance with certain aspects of the present disclosure.

### DESCRIPTION OF EXAMPLE IMPLEMENTATIONS

### Overview

According to one or more implementations of the disclosure, a device may obtain operational attributes across a plurality of spans associated with a monitored transaction over a network. The device may provide the operational attributes for configuration as an operational metric attribute and as dimension attributes corresponding to the operational metric attribute. The device may generate, based on the configuration, an operational metric measurement corresponding to the operational metric attribute and one or more dimensions corresponding to the dimension attributes. The device may provide the operational metric measurement for at least one of the one or more dimensions for operational analysis.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

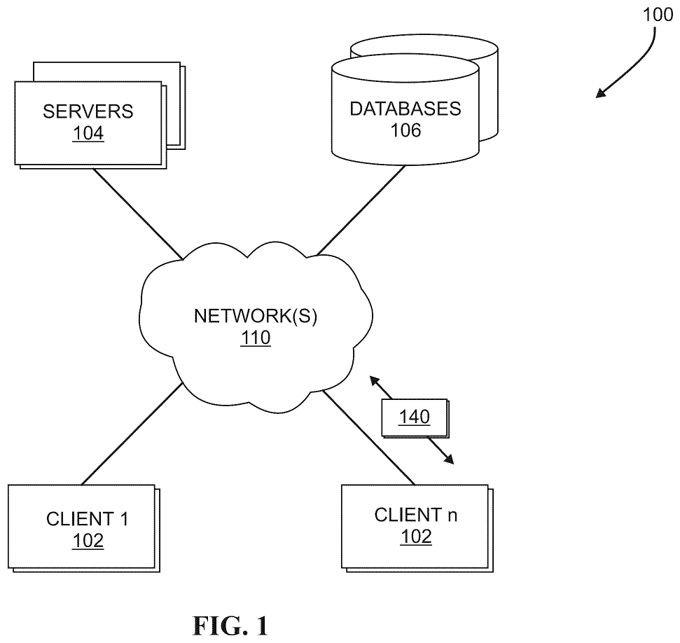

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

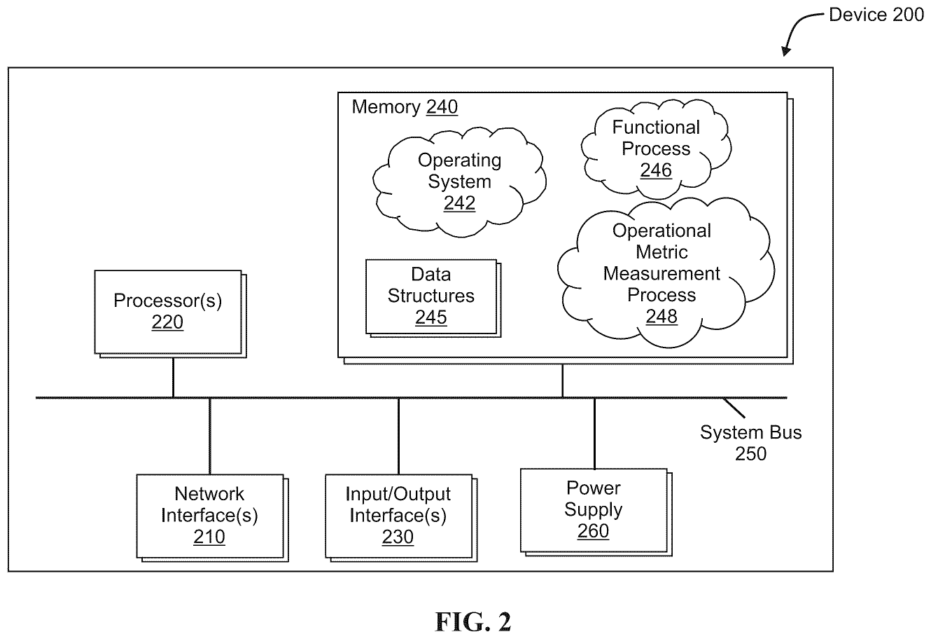

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes (e.g., functional processes 246), and on certain devices, an illustrative operational metric measurement process 248, as described herein. Notably, functional processes 246, when executed by processor 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, operational metric measurement process 248 may include computer executable instructions that, when executed by processor 220, cause device 200 to perform the techniques described herein. To do so, in some implementations, operational metric measurement process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, operational metric measurement process 248 may employ one or more supervised, unsupervised, or semi-supervised machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that operational metric measurement process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, operational metric measurement process 248 may also include, or otherwise use, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of operational metric analysis, operational metric measurement process 248 may use a generative model to generate baselines for certain operational metric measurements. Example generative approaches can include, but are not limited to, generative adversarial networks (GANs), foundation models such as large language models (LLMs), other transformer models, and the like.

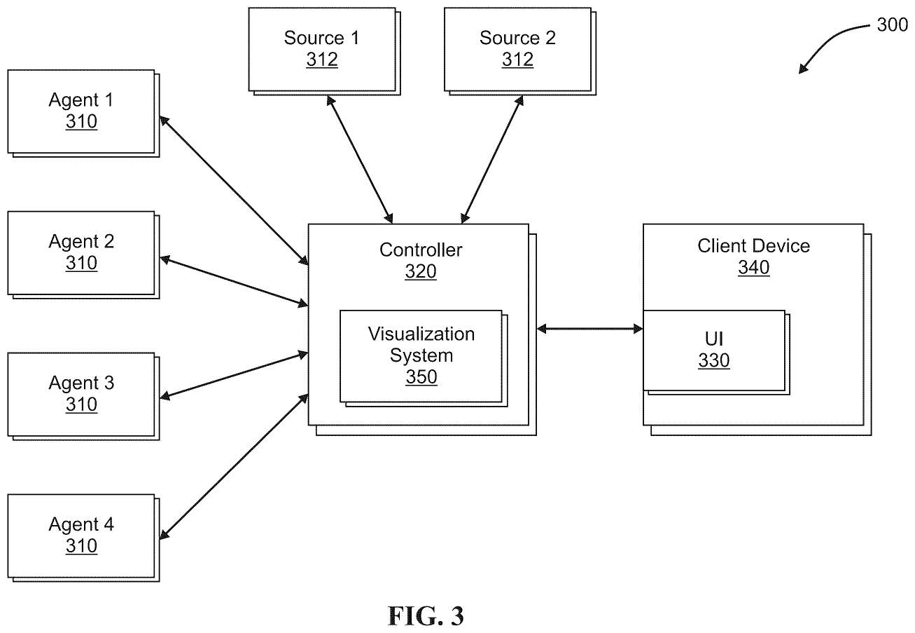

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents (e.g., agents 310), one or more sources (e.g., sources 312), and one or more servers/controllers (e.g., controller 320). Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a user interface 330 (denoted UI in FIG. 3), such as a browser-based UI, that is the primary interface for monitoring, analyzing, and troubleshooting the monitored environment. Specifically, the controller 320 can receive data from agents 310, sources 312 (and/or other coordinator devices), associate portions of data (e.g., topology, transaction end-to-end paths and/or metrics, etc.), communicate with agents to configure collection of the data (e.g., the instrumentation/tests to execute), and provide performance data and reporting through user interface 330. User interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, an instance of controller 320 may be hosted remotely by a provider of the observability intelligence platform 300. In an illustrative on-premises (On-Prem) implementation, a controller 320 may be installed locally and self-administered.

The controllers 320 receive data from the agents 310 (e.g., Agents 1-4) and/or sources 312 deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application. Further, the controllers 320 can receive data from sources 312 (e.g., sources 1-2). Any of the sources can be implemented to provide various types of observability data that can include information, metrics, telemetry data, business data, network data, etc.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be implemented as small files using web-based technologies, such as JavaScript agents injected into each instrumented web page (e.g., as close to the top as possible) as the web page is served and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain implementations, in the application intelligence model, a transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

An application transaction, in particular, is a representation of the particular service provided by the monitored environment that provides a view on performance data in the context of the various tiers that participate in processing a particular request. That is, an application transaction, which may be identified by a unique application transaction identification (ID), represents the end-to-end processing path used to fulfill a service request in the monitored environment (e.g., adding items to a shopping cart, storing information in a database, purchasing an item online, etc.). Thus, an application transaction is a type of user-initiated action in the monitored environment defined by an entry point and a processing path across application servers, databases, and potentially many other infrastructure components. Each instance of an application transaction is an execution of that transaction in response to a particular user request (e.g., a socket call, illustratively associated with the TCP layer). An application transaction can be created by detecting incoming requests at an entry point and tracking the activity associated with request at the originating tier and across distributed components in the application environment (e.g., associating the application transaction with a 4-tuple of a source IP address, source port, destination IP address, and destination port). A flow map can be generated for an application transaction that shows the touch points for the application transaction in the application environment. In one implementation, a specific tag may be added to packets by application specific agents for identifying application transactions (e.g., a custom header field attached to a hypertext transfer protocol (HTTP) payload by an application agent, or by a network agent when an application makes a remote socket call), such that packets can be examined by network agents to identify the application transaction identifier (ID) (e.g., a Globally Unique Identifier (GUID) or Universally Unique Identifier (UUID)). Performance monitoring can be oriented by application transaction to focus on the performance of the services in the application environment from the perspective of end users. Performance monitoring based on application transactions can provide information on whether a service is available (e.g., users can log in, check out, or view their data), response times for users, and the cause of problems when the problems occur.

In accordance with certain implementations, both self-learned baselines and configurable thresholds may be used to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or application transaction) or associated infrastructure, such as, e.g., load, average response time, rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the extensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is contemplated that various processes may be implemented across multiple devices, on different devices, utilizing additional devices, and so on, and the views shown herein are merely simplified examples that are not meant to be limiting to the scope of the present disclosure.

As noted above, operational metrics are of great interest to many, including entities operating transaction platforms. This metrics may be leveraged to provide insights into various aspects of a platform's operation as well as the applications impact on business operations and/or transactional outcomes. Most of the solutions available for monitoring operational metrics rely on custom metrics or span metrics for their needs.

The challenge with such approaches is that not all dimensions required to analyze the metric data are available in the same span. For example, telemetry data collector trace processing connectors (e.g., OpenTelemetry (OTEL)) can be potentially used to achieve the purpose of collecting metric measurement and dimensions from attributes from different spans. However, this solution is complex to configure and maintain.

While custom metrics or span metrics may be used for the purpose of monitoring operational metrics, such approaches have their drawbacks. In general, custom metrics are emitted from the application and are usually aggregated in a time series for presentation. In case of custom metrics, the measurements are usually generated in the application with the help of a telemetry metrics (e.g., OpenTelemetry Metrics) software development kit (“SDK”). These measurements usually have dimensions attached and are aggregated in a time series fashion in an observability solution.

Span metrics may be emitted by a custom telemetry connector (e.g., OpenTelemetry Connector) which can be used to scrape span attributes to generate metric measurements with the required dimensions. This approach also allows metric measurements with the desired dimensions to be emitted. This approach can also be used to potentially build a custom collector that emits the measurements by processing the entire trace. However, this approach is very complex, as it may require code changes and multiple iterations to get the desired functionality in place.

Custom metrics or span metrics may serve the purpose if the metric and the dimension of interest originate from a single span. But in modern distributed architectures in the cloud, an application consists of multiple microservices. A single business transaction can have spans across tens or hundreds of microservices. In such deployments, it is difficult to correlate different dimensions for the same metric across spans.

### —Operational Metric Support on a Cloud-Based Observability Platform—

In contrast, the techniques herein introduce a powerful mechanism for enterprise owners to monitor key performance indicators (“KPIs”) for their business alongside application performance. The easy configuration experience of this feature allows the customer to tackle the complexity of generating metric measurements based on attributes scattered across multiple spans of a transaction (e.g., a business transaction). It also enables users to ability to slice the operational metric data in segments and allow the user to set up health rules.

Illustratively, the techniques described herein may be performed by hardware, software, and/or firmware, such as in accordance with operational metric measurement process 248, which may include computer executable instructions executed by the processor 220 (or independent processor of interfaces 210) to perform functions relating to the techniques described herein.

Specifically, according to various implementations, a device may obtain operational attributes across a plurality of spans associated with a monitored transaction over a network. The device may provide the operational attributes for configuration as an operational metric attribute and as dimension attributes corresponding to the operational metric attribute. The device may generate, based on the configuration, an operational metric measurement corresponding to the operational metric attribute and one or more dimensions corresponding to the dimension attributes. The device may provide the operational metric measurement for at least one of the one or more dimensions for operational analysis.

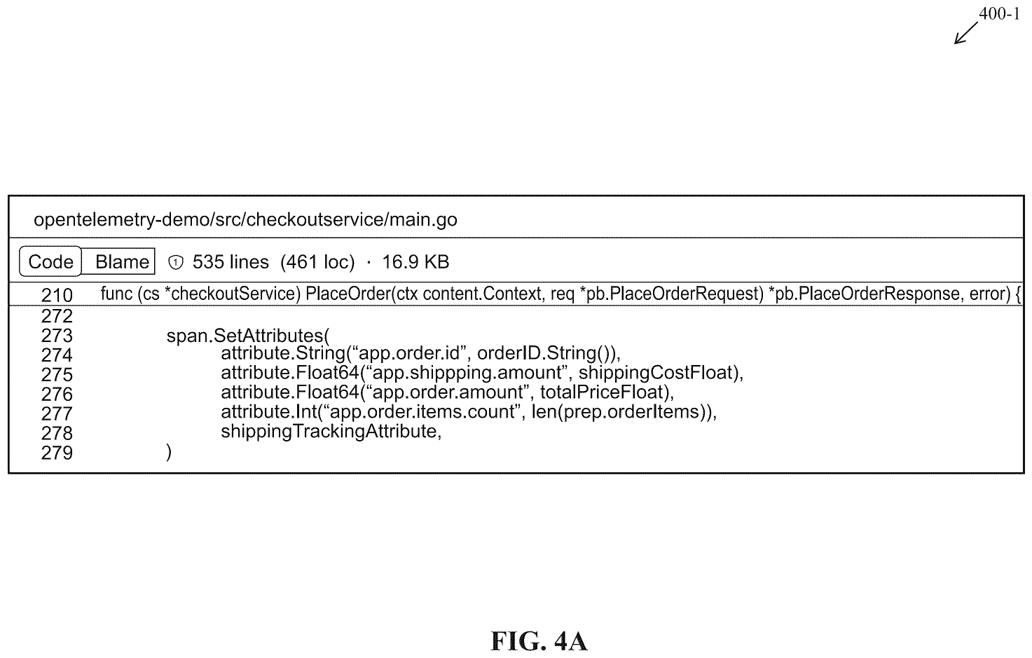

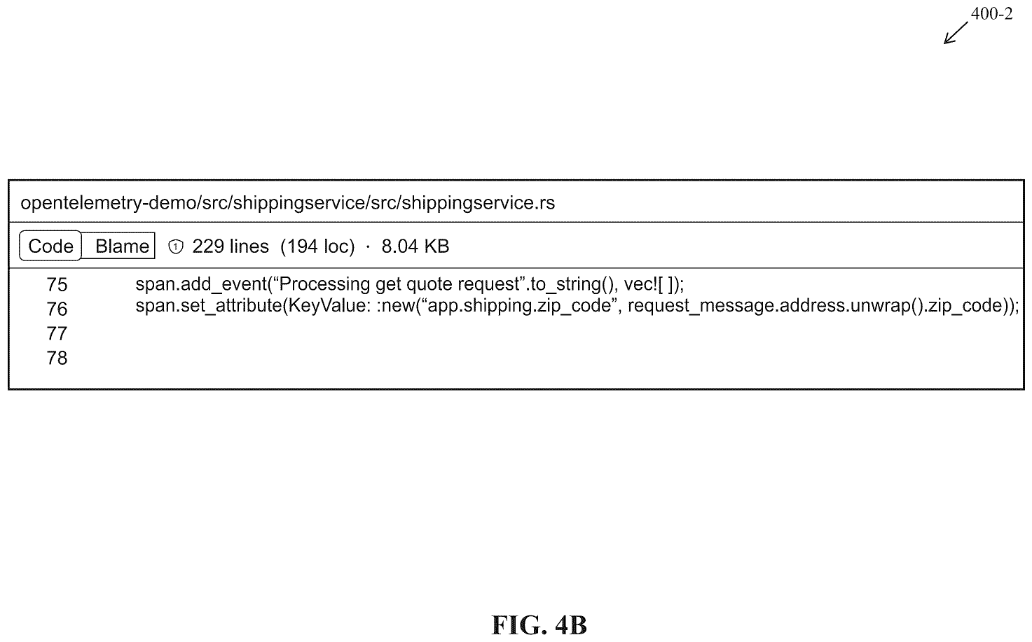

Operationally, FIGS. 4A-4B illustrate examples of instrumentations 400 (e.g., instrumentation 400-1 and instrumentation 400-2) of code to service spans to provide attributes for operational metric support on a cloud-based observability platform, according to various implementations. Instrumentations 400 may be components of an operational use case of tracking Total Revenue for an ecommerce application and then further analyzing the data based on shipping zip code. Instrumentations 400 may be components of an application of an operational metric collection utility.

The operational metric collection utility may be configured to ameliorate the incomplete and fragmented metric data collection in distributed systems associated with existing approaches. The operational metric collection utility may accomplish this by traversing the operational transaction spans (e.g., business transaction spans) and collecting all the metrics and dimensions as part of a single measurement. Doing so may facilitate a user in selecting one attribute to generate a measurement and other attributes as dimensions. This may empower a user with the data to perform multidimensional metric data analyses to gain deep insights into the performance of their enterprise.

The operational metric collection utility may also provide a unique configuration experience. Prescriptive templates can be provided for users to easily configure the metrics for their use cases. For example, a “Sum” template can be used for operational use cases, such as Total Revenue or Total Products Sold, and these templates only add the measurement if the originating span status is not Error. Such approaches may avoid the problem where a transaction fails and yet the measurement gets added in the sum attribute. Additionally, users can also get a visual data preview during the configuration allowing them to select the attribute.

In various implementations, a user (e.g., business owner) conveys a use case, (e.g., tracking total revenue for an ecommerce application and then further analyzing the data based on shipping zip code), to development-operations (“DevOps”) personnel. The DevOps personnel may identify the services that are the subjects of that use case (e.g., checkout and shipping service) as the instrumentation targets and instructs the developers to add the required operational attributes. The developers accordingly instrument the code.

For example, instrumentation 400-1 is an example of an instrumentation of the checkout service (“checkoutService”) span with an “app.order.amount” attribute on line two hundred seventy-six. Here, the order amount attribute is specified:
span. SetAttributes { . . . , attribute.Float64 (“app.order.amount”, totalPriceFloat), . . . }. These changes result in the “app.order.amount” attribute being added as a span attribute for its respective spans for the checkout service.

Likewise, instrumentation 400-2 is an example of an instrumentation of the shipping service (“shippingservice”) span with “app.shipping.zip_code” attribute on line seventy-seven. Here, the shipping zip code attribute is specified:
span.set_attributes (KeyValue:: new (“app.shipping.zip_code”, request_message.address.unwrap ( ) zip_code)).

These changes result in the “app.shipping.zip_code” attribute being added as a span attribute for it respective spans for the shipping service.

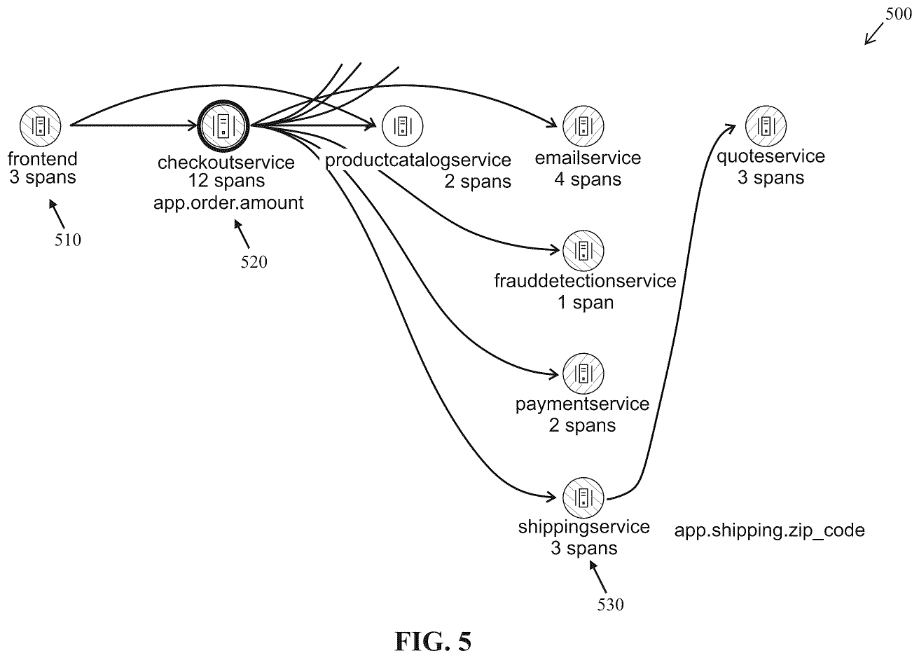

FIG. 5 illustrates an example of a service map 500 for a transactional application. The positions of the app.order.amount and the app.shipping.zip_code attributes are illustrated within service map 500 for a transactional application.

In service map 500, an online transaction is illustrated beginning with a frontend span 510, which can include, for example, receiving input from an online buyer. The frontend span 510 in this example has three child spans, including the checkout service span 520 (“checkoutservice”), in which the order amount attribute (“app.order.amount”) is instrumented. The checkout service span 520 in this example has twelve child spans, including the shipping service span 530 (“shippingservice”) in which the shipping zip code attribute (“app.shipping.zip_code”) is instrumented. The shipping service span 530 has three child spans for further tasks toward the online transaction. With the spans instrumented with the appropriate oeprational attributes, the trace may be processed in the cloud.

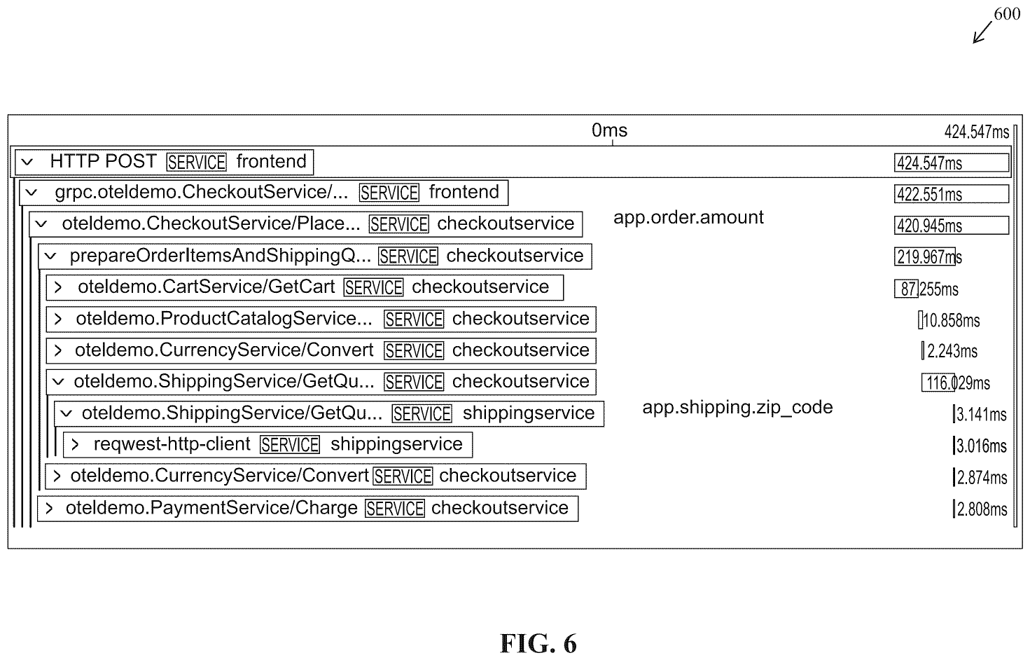

FIG. 6 illustrates an example of a trace view 600 of a checkout transaction. In this example, the trace view 600 shows the spans included in the trace and the order of execution in the trace. While processing the trace in the cloud, the attributes of interest are scraped and later used (e.g., presented for configuration). The app.order.amount and app.shipping.zip_code attributes are scraped an annotated in trace view 600.

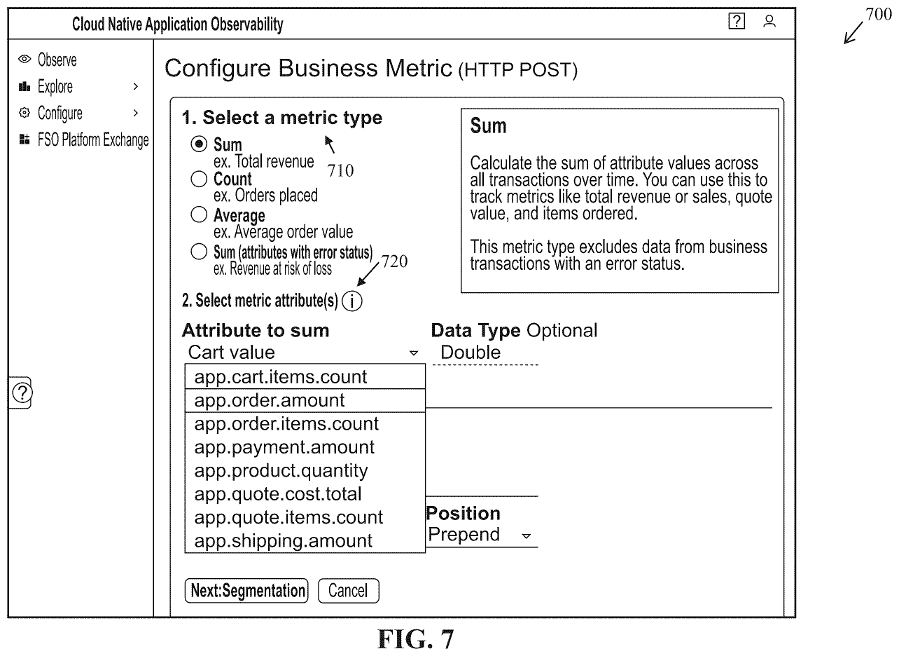

FIG. 7 illustrates an example of an operational metric configuration interface 700. Once the spans are instrumented with the appropriate operational attributes, such as order amount and shipping zip code, a user, such as the DevOps personnel, can configure operational metrics, i.e., by selecting and/or constructing an operational metric from an operational attribute and selecting one or more operational attributes as dimensions for operational attribute analysis.

For example, DevOps personnel may go to the checkout transaction webpage, navigate to the operational metric section, and begin configuration. For instance, a Sum operation template can be selected for the use case and the metric attribute may be selected. The list of metric attributes and data type may be generated using the attributes scraped from the trace.

Operational metric configuration interface 700 may be presented to a user, such as a DevOps personnel. In this example, the user is presented with various metric types 710 and attributes 720 from which the metric types are derived. For example, if the attribute app.order.amount is chosen, then the Sum metric type represents the total revenue from the transactions. Here, the attributes with only summable data type are displayed in the list. The attribute for zip code is a string and not listed here.

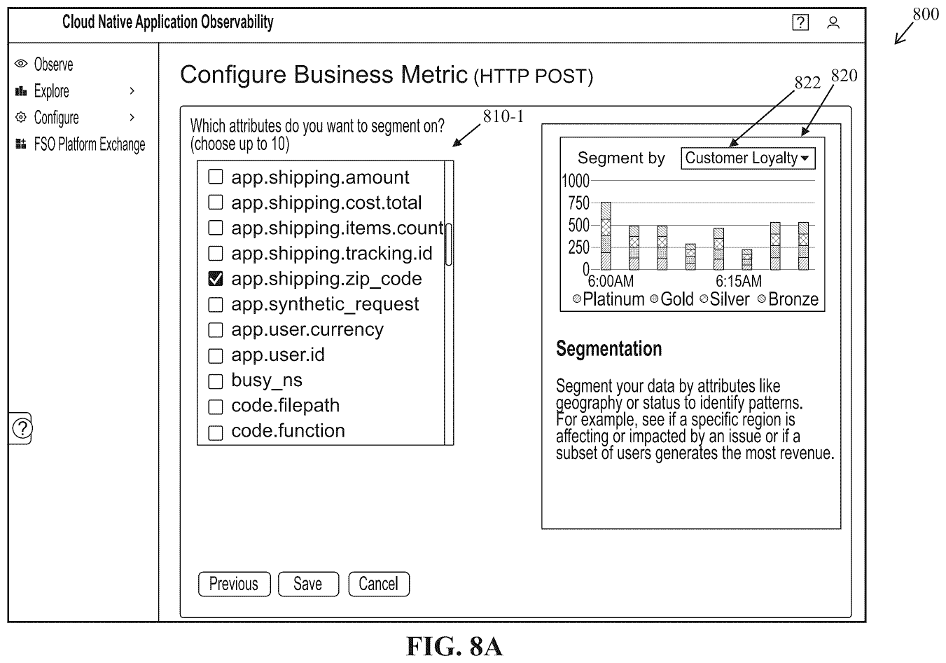

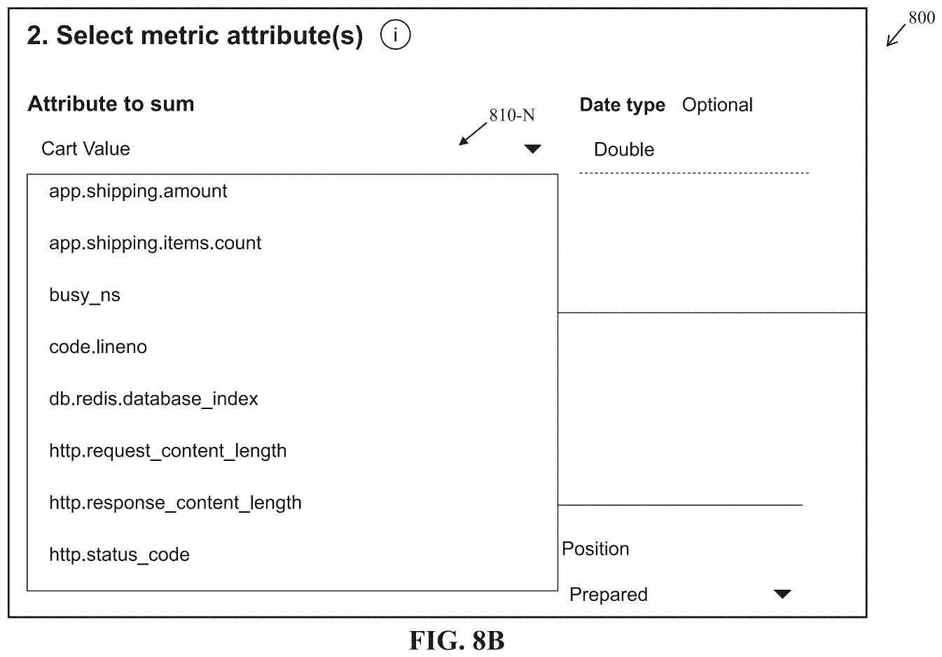

FIGS. 8A-8B illustrate examples of selection interfaces 810 (e.g., selection interface 810-1 and selection interface 810-N) for selecting segmentation of metric data in an operational configuration interface 800. After selecting the desired title for the metric template, the segmentation attributes on which the operational metric is to be segmented on are selected via the selection interface for analysis and/or visualization. For example, a zip code may be an attribute of interest. As such, the app.shipping.zip_code attribute may be chosen in selection interface 810-1. Note that in some implementations, multiple segmentation attributes (e.g., up to ten, etc.) can be selected to be potentially segmented on. This may complete the configuration for the selected use case.

In various implementations, the selected operational metric can be displayed, for example, as a preview, at a user interface, such as operational configuration interface 800. For example, a chart (e.g., bar graph) 820 is presented to the user in the form of total revenue per unit time versus time of the day, and each graphical representation of a total revenue (e.g., a bar in a bar graph) divided into sections representing the segmentation attribute selected from the attributes chosen during configuration. In this example, customer loyalty is selected using a dropdown menu 822.

The operational metric configuration process may be further simplified by filtering out semantic convention attributes (e.g., OTEL semantic convention) from a list of operational attributes, or by giving operational attributes characteristics that distinguish them from semantic convention attributes. For example, in selection interface 810-1, the operational attributes are each given the “app.” prefix (e.g., “app.shipping.zip_code” and “app.sipping.items.count”), whereas the semantic convention attributes (e.g., “code.filepath”) do not have this prefix. In another example, selection interface 810-N includes operational attribues (e.g., “app.shipping.amount”) with the distinctive “app.” prefix, and semantic convention attribute (e.g., “http.request_content_length”) without the “app.” prefix.

Such filtering may help DevOps personnel easily identify and configure operational attributes for the metric and segmentation attributes selection. In further implementations, this functionality can be extended to allow the customer to configure the list of semantic convention attributes to be included in the attribute preview. In various implementations, the cardinality of the attributes is presented during the data preview allowing the customer to select the correct attribute for segmentation.

In some implementations, prescriptive templates for tracking operational metrics may be provided. For example, Sum, Count and Average template may be used to include measurements for a metric in which the originating span status of the transaction is not ERROR.

The Sum (attributes with Error status) template may be used to sum up the measurements where the originating span status of the transaction is ERROR. The definition of the error state for a span may be defined in an OTel specification.

A transaction with such an ERROR status may be interpreted as the transaction having “failed.” However, the techniques described herein may extend this analysis, building on the pattern from Cybersecurity as a Service (“CSaaS”) analysis to interpret the ERROR status as a potential indication that a user may be frustrated or about to give up. Thus, the sum of attributes with ERROR status may be identified and/or labeled as “Revenue at risk of loss.” In some implementations, the customer may be permitted to configure operational metrics based on ERROR span status to reveal relationships between Browser Sessions (e.g., a single user's visit to multiple website pages in succession) featuring an abandoned cart and the presence of ERROR spans.

In some implementations, the user is permitted to associate any other span attributes with an error or failure state, and easily measure the total. For example, a user interface (“UI”) enables the user to select spans where there is an attribute like “out of stock message shown” or another status and find the total revenue for products or orders where such conditions occurred.

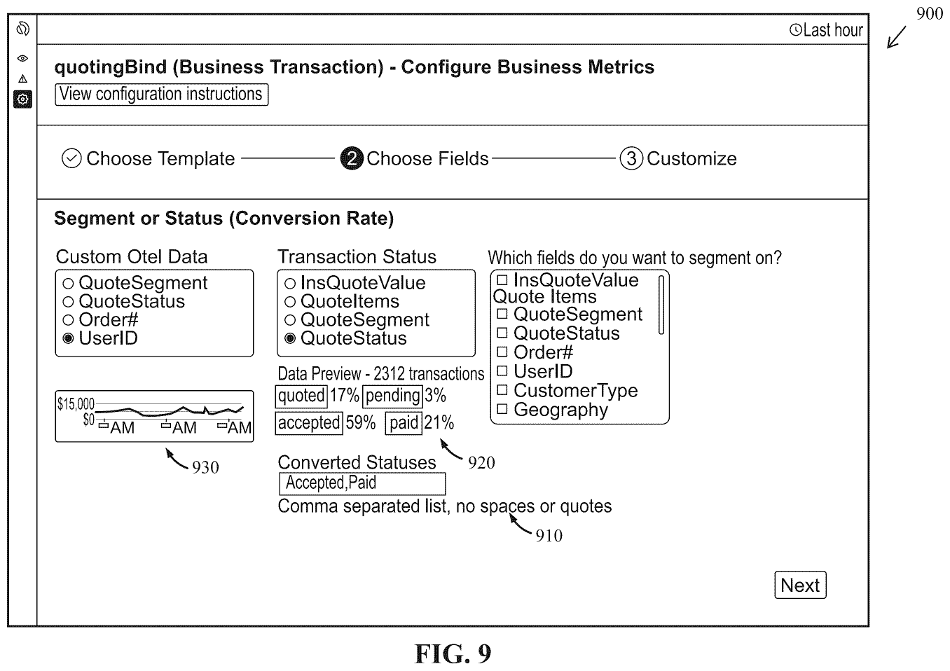

FIG. 9 illustrates an example of a conversion rate template 900 for operational metric support on a cloud-based observability platform, according to various implementations. Conversion rate template 900 provides another example of using ERROR status or other span status associated with a failure. Here, a user can configure an operational metric 910, such as sales accepted or paid, that is at least partially based the number or percentage of transactions that did not have an ERROR or other failure status. The metric can be displayed as numerical conversion rates 920 and/or displayed graphically, for example, as a plot 930 of conversion rate versus time. By letting users choose to filter based on the value or status of an attribute that represents a completed sale or other type of transaction, conversion rates can be easily calculated.

Often business users are concerned that the data may be easily misinterpreted when it is shared across a large organization. However, the described operational metric configuration user interfaces may permit users to configure labels naming the metrics. User-configurable operational metric labels in some cases help ensure that anyone viewing the metrics will interpret them properly. Further, metadata may be added to certain data after user interaction and/or provided to users to enable them to determine the provenance or source of the data (e.g., OTel attribute name, service name, and variable name). This will provide certain details about operational metrics when detailed questions arise, such as “does this revenue figure include returned items?”.

In further implementations, the operational metric configuration user interface may enable the user to add and/or view comments, descriptions, metadata, notes, etc. to a metric. For instance, a user may leverage the operational metric configuration user interface to add and/or view a comment such as “this calculation is taken from the pre-reconciliation step of the Checkout flow, so it does include orders that may be cancelled or changed later.” Likewise, a user and/or analysis utility may leverage the comments, descriptions, metadata, notes, etc. to generate such a conclusion.

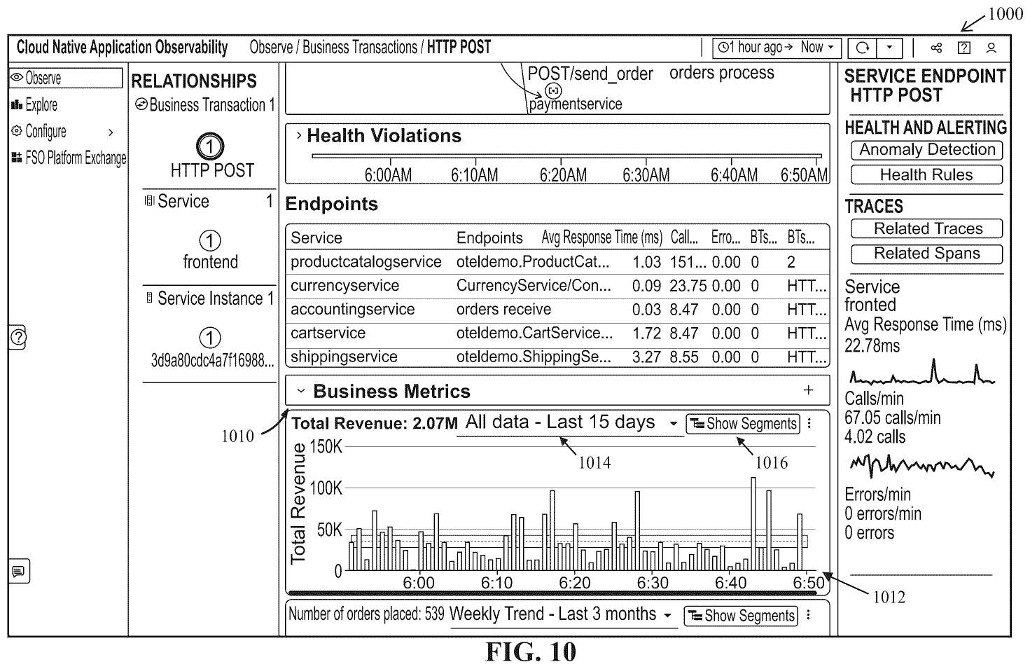

FIG. 10 illustrates an example of an operational metric analysis interface 1000 for operational metric support on a cloud-based observability platform, according to various implementations. Once the operational metric and segmentation attributes are configured, a user, such as a business owner, can use the configured metric for operational analysis. In some implementations, the metric appears operational metrics section 1010 of the operational metric analysis interface 1000.

A user can utilize the operational metrics section 1010 of the operational metric analysis interface 1000 to examine the metric data on a timeline 1012 on a scale selected using a global time selector 1014, which in this example provides options to show a 15-day, 30-day or 90-day baseline. For analysis based on segments the customer can click on the “Show Segments” dropdown menu 1016 to analyze revenue based on zip codes. The individual values can be analyzed by selecting them on the x-axis.

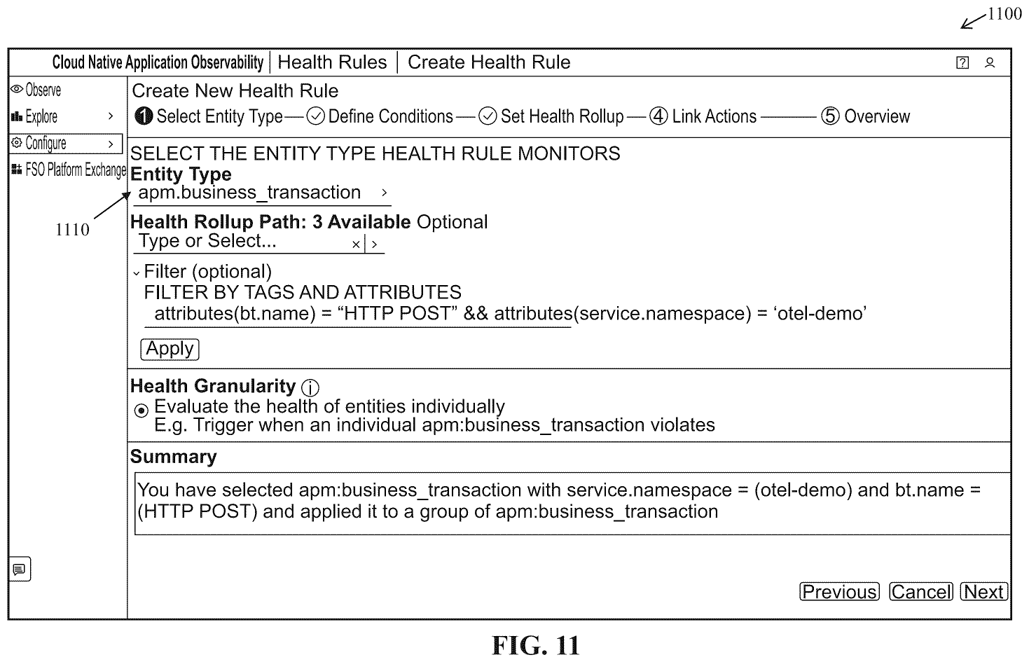

FIG. 11 illustrates an example of a health rule configuration interface 1100 for operational metric support on a cloud-based observability platform, according to various implementations. Health rule configuration interface 1100 may be utilized for health rule configuration based on operational transaction entity and associated operational metric.

Users can optionally set up health rules to make sure that a metric of interest is within an expected range. The user may follow the same health rule setup flow as would be followed for any other operational transaction metric. As part of the setup, the user may designate an entity type 1110. Health rules can also be configured on segment. The entity type selected determines the metrics that are offered for configuring the evaluation conditions.

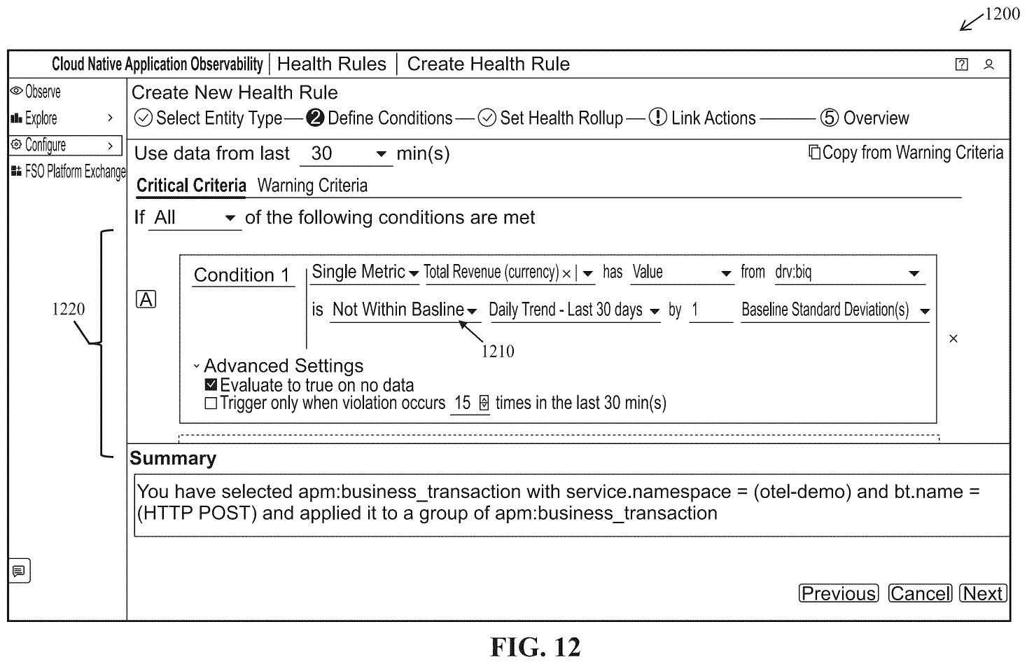

FIG. 12 illustrates an example of a health rule evaluation condition configuration interface 1200 for operational metric support on a cloud-based observability platform, according to various implementations. Health rule evaluation condition configuration interface 1200 may be utilized to configure evaluation conditions 1220, which represent criteria that when met warnings and/or violations of health rules. The entity type selected may determine the metrics that are offered for configuring the evaluation conditions. In various implementations, the evaluation conditions 1220 may be specified in terms of a deviation 1210 of an operational metric from a baseline.

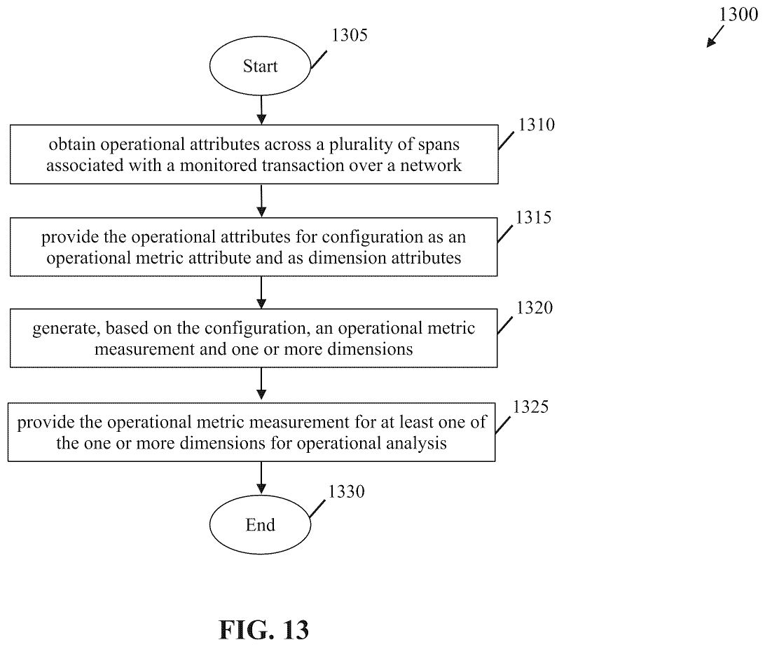

FIG. 13 illustrates an example simplified procedure for operational metric support on a cloud-based observability platform in accordance with certain aspects of the present disclosure. For example, a non-generic, specifically configured device connected to a computer network for operational metric measurements (e.g., device 200), may perform procedure 1300 (e.g., a method) by executing stored instructions (e.g., operational metric measurement process 248).

The procedure 1300 may start at step 1305, and continue to step 1310, where, as described in greater detail above, the device (e.g., a controller, processor, etc.) may obtain operational attributes across a plurality of spans associated with a monitored transaction over a network. In some instances, one of the plurality of spans associated with the monitored transaction may have respective error status, which may influence how the attributes associated with that span are processed and/or analyzed.

At step 1315, as detailed above, the device may provide the operational attributes for configuration as an operational metric attribute and as dimension attributes corresponding to the operational metric attribute. The configuration may be based on user selections input to predefined templates configured for one or more of a sum operation, an average operation, and/or a count operation.

At step 1320, the device may generate, based on the configuration, an operational metric measurement corresponding to the operational metric attribute and one or more dimensions corresponding to the dimension attributes. In instances where at least one of the plurality of spans associated with the monitored transaction has a respective error status, the operational metric measurement may be generated based on the respective error status.

Generating the operational metric measurement may include generating a combination of operational metric measurements including operational metric measurements from a plurality of monitoring transactions and excluding from the combination of operational metric measurements all of the operational metric measurements having an associated span with an error status. Alternatively, generating the operational metric measurement may include generating a combination of operational metric measurements including only operational metric measurements having an associated span with an error status.

In various implementations, generating the operational metric measurement may include generating a graphical representation of the operational metric attribute across the one or more dimensions. The graphical representation may be configurable to display selectable dimensional segments of the operational metric attribute specified in the configuration. The operational metric measurement may be labeled with a user-configured label, which helps ensure that anyone viewing the metrics will interpret them properly.

At step 1325, the device may provide the operational metric measurement for at least one of the one or more dimensions for operational analysis. The operational metric measurement may be generated based on a user-defined relationship between the operational metric measurement and the operational attributes.

In various implementations, procedure 1300 may include obtaining a rule configuration defining an evaluation condition for determining whether the operational metric measurement is within an expected range. Then, the operational metric measurement may be evaluated based on the rule configuration.

The procedure 1300 then ends at step 1330.

It should be noted that while certain steps within procedure 1300 may be optional as described above, the steps shown in FIG. 13 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, provide monitoring and analysis of operational metrics within distributed system by leveraging advanced telemetry data collection and processing. By traversing operational transaction spans and scraping operational attributes from multiple spans of a transaction, these techniques deliver comprehensive aggregations of metrics and dimensions. Users benefit from an intuitive configuration process facilitated by visual data previews and predefined templates, allowing them to confidently identify key operational metrics and dimensions across different spans associated with a transaction. The ability to dynamically generate and update operational metric measurements in real time combined with user configurable labels also enhances interpretability and relevance. Additionally, these techniques incorporate error state analysis, enabling detailed insights into transaction failures and their causes.

Further, the techniques introduce health rules and alerts that provide proactive monitoring, ensuring metrics remain within expected ranges. The techniques introduce robust data visualization tools that further supports in-depth analysis and long-term performance tracking. This end-to-end solution simplifies the complex task of metric configuration, offering a powerful tool for business owners to monitor KPI's effectively, identify trends, and make informed decisions.

While there have been shown and described illustrative implementations that provide for operational metric support on a cloud-based observability platform, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
obtaining, by a device, operational attributes across a plurality of OpenTelemetry spans associated with a monitored transaction over a network;
providing, by the device, the operational attributes for configuration as an operational metric attribute and as dimension attributes corresponding to the operational metric attribute;
generating, by the device and based on the configuration, an operational metric measurement corresponding to the operational metric attribute and one or more dimensions corresponding to the dimension attributes; and
providing, by the device, the operational metric measurement for at least one of the one or more dimensions for operational analysis.

2. The method of claim 1, wherein the configuration is based on selections input to predefined templates configured for one or more of a sum operation, an average operation, or a count operation.

3. The method of claim 1, wherein the operational metric measurement is generated based on a user-defined relationship between the operational metric measurement and the operational attributes.

4. The method of claim 1, further comprising:
obtaining a rule configuration defining an evaluation condition for determining whether the operational metric measurement is within an expected range; and
evaluating the operational metric measurement based on the rule configuration.

5. The method of claim 1, wherein at least one of the plurality of spans associated with the monitored transaction has a respective error status, and wherein the operational metric measurement is generated based on the respective error status.

6. The method of claim 1, wherein generating the operational metric measurement includes:
generating a combination of operational metric measurements including operational metric measurements from a plurality of monitoring transactions; and
excluding from the combination of operational metric measurements all of the operational metric measurements having an associated span with an error status.

7. The method of claim 1, wherein generating the operational metric measurement includes generating a combination of operational metric measurements including only operational metric measurements having an associated span with an error status.

8. The method of claim 1, wherein generating the operational metric measurement includes generating a graphical representation of the operational metric attribute across the one or more dimensions.

9. The method of claim 8, wherein the graphical representation is configurable to display selectable dimensional segments of the operational metric attribute defined in the configuration.

10. The method of claim 1, further comprising:
labeling the operational metric measurement with a user-configured label.

11. An apparatus, comprising:
one or more network interfaces for connection to a computer network;
a processor coupled to the one or more network interfaces and configured to execute one or more processes;
a user interface; and
a memory configured to store a process that is executable by the processor, the process when executed being configured to:
obtain operational attributes across a plurality of OpenTelemetry spans associated with a monitored transaction over a network;
provide the operational attributes for configuration as an operational metric attribute and as dimension attributes corresponding to the operational metric attribute;
generate, based on the configuration, an operational metric measurement corresponding to the operational metric attribute and one or more dimensions corresponding to the dimension attributes; and
provide the operational metric measurement for at least one of the one or more dimensions for operational analysis.

12. The apparatus of claim 11, wherein the configuration is based on selections input to predefined templates configured for one or more of a sum operation, an average operation, or a count operation.

13. The apparatus of claim 11, wherein the operational metric measurement is generated based on a user-defined relationship between the operational metric measurement and the operational attributes.

14. The apparatus of claim 11, wherein the process is further configured to:
obtain a rule configuration defining an evaluation condition for determining whether the operational metric measurement is within an expected range; and
evaluate the operational metric measurement based on the rule configuration.

15. The apparatus of claim 11, wherein at least one of the plurality of spans associated with the monitored transaction has a respective error status, and wherein the operational metric measurement is generated based on the respective error status.

16. The apparatus of claim 11, wherein the process is further configured to:
generate a combination of operational metric measurements including operational metric measurements from a plurality of monitoring transactions, excluding from the combination of operational metric measurements all of the operational metric measurements having an associated span with an error status.

17. The apparatus of claim 11, wherein the process is further configured to:
generate the operational metric measurement by generating a combination of operational metric measurements including only operational metric measurements having an associated span with an error status.

18. The apparatus of claim 11, wherein the process is further configured to:
generate the operational metric measurement by generating a graphical representation of the operational metric attribute across the one or more dimensions.

19. The apparatus of claim 18, wherein the graphical representation is configurable to display selectable dimensional segments of the operational metric attribute defined in the configuration.

20. A tangible, non-transitory, computer-readable medium storing program instructions that cause a device to execute a process comprising:
obtaining operational attributes across a plurality of OpenTelemetry spans associated with a monitored transaction over a network;
providing the operational attributes for configuration as an operational metric attribute and as dimension attributes corresponding to the operational metric attribute;
generating, based on the configuration, an operational metric measurement corresponding to the operational metric attribute and one or more dimensions corresponding to the dimension attributes; and
providing the operational metric measurement for at least one of the one or more dimensions for operational analysis.
